(19) United States
(12) Patent Application Publication
(10) Pub. No.: US 2014/0269184 A1
(43) Pub. Date: Sep. 18, 2014

(54) LAND HYDROPHONE AND METHOD

(71) Applicant: CGG Services SA, Massy Cedex (FR)

(72) Inventors: John SALLAS, Plano, TX (US); Peter MAXWELL, Missouri City, TX (US)

(73) Assignee: CGG SERVICES SA, Massy Cedex (FR)

(21) Appl. No.: 14/136,220

(22) Filed: Dec. 20, 2013

Related U.S. Application Data
(60) Provisional application No. 61/790,918, filed on Mar. 15, 2013.

(51) Int. Cl. G01V 1/52

(52) U.S. Cl. CPC G01V 1/52
USPC 367/25

(57) ABSTRACT

A seismic sensor system collects seismic data in a well. The system includes a pipe to be deployed inside the well, the pipe having a distal end; a first sensor located inside the pipe, next to the distal end; and a bladder jacket in which the pipe is placed, the bladder jacket being configured to hold a fluid. The pipe has holes next to the first sensor so that the fluid surrounds and contacts the first sensor.

### BACKGROUND

1. Technical Field

Embodiments of the subject matter disclosed herein generally relate to methods and systems for collecting seismic data using a vertical hydrophone cable or a buried hydrophone and, more particularly, to mechanisms and techniques for increasing a coupling of a hydrophone with the ground.

2. Discussion of the Background

Land seismic data acquisition and processing may be used to generate a profile (image) of the geophysical structure under the ground (subsurface). While this profile does not provide an accurate location for oil and gas reservoirs, it suggests, to those trained in the field, the presence or absence of such reservoirs. Thus, providing a high-resolution image of the subsurface is important, for example, to those who need to determine where oil and gas reservoirs are located.

Traditionally, as illustrated in FIG. 1, a land seismic survey 100 that uses vertical hydrophone cables is performed in the following way. Plural hydrophones 102 are electrically connected to each other along a cable 104. A well 106 is dug into the ground 108 to accommodate the plural hydrophones. Then, the borehole is filled with water and a packer may be installed to trap the water.

After all the hydrophones have been deployed, one or more seismic sources are brought into the field and actuated to generate seismic waves, which propagate through the ground until they are reflected by various reflectors. The reflected waves propagate to the hydrophones, where a pressure change of the earth is recorded. However, if the generated pressure waves encounter any obstacles along their paths that extend through the ground, well, water and hydrophone, the recorded data is of poor quality.

A hydrophone typically has a cylindrical shape and a small size. Thus, a gap between the hydrophone and the well might be a problem when the hydrophone does not tightly fit into the well (supposing that the hydrophone is directly placed into the well). The pressure wave path is improved if the hydrophone's diameter is close to the diameter of the well, i.e., if the hydrophone is in tight contact with the well's walls. However, obtaining tight contact is difficult. Thus, the coupling between the ground and hydrophone is traditionally poor, and also not well understood. The hydrophone-ground coupling may be defined as the difference between the pressure measured by the hydrophone and the pressure in the ground without the hydrophone. This definition is appropriate for designing a hydrophone.

However, once the hydrophone is designed and needs to be deployed, the practicing geophysicist has to deal with the fact that the hydrophone may not be appropriately deployed. For example, the hydrophone may not be “well” coupled to its surroundings. In this situation, the above definition might not be appropriate. For this situation, what those skilled in the art would consider a “bad” hydrophone coupling refers to the difference between the pressure as measured by the badly coupled hydrophone and the pressure as measured by the well-coupled hydrophone.

Irrespective of the used definition, the ground-hydrophone coupling is a persistent problem in the art because it is difficult to make the casing of the hydrophone to have tight contact with the well and, at the same time, to ensure that the hydrophones are easily inserted and/or retrievable from the well. One method known in the industry is to attach a cable 110 with high mechanical resistance to the casing of each hydrophone and, when it is time to remove the hydrophones, to pull this cable up. However, if the well has collapsed at the location of one hydrophone, that hydrophone may be stuck at that position, and even pulling the cable 110 may not retrieve the hydrophone.

Therefore, there is a need to improve the coupling of the hydrophone to the ground and at the same time to make easier and safer the process of retrieving the hydrophones.

### SUMMARY OF THE INVENTION

According to an embodiment, there is a seismic sensor system for collecting seismic data in a well. The system includes a pipe to be deployed inside the well, the pipe having a distal end; a first sensor located inside the pipe, next to the distal end; and a bladder jacket in which the pipe is placed, the bladder jacket being configured to hold a fluid. The pipe has holes next to the first sensor so that the fluid surrounds and contacts the first sensor.

According to another embodiment, there is a seismic sensor system for collecting seismic data in a well. The system includes a support member configured to be lowered into the well; a bag attached to the support member and configured to contain a fluid; a feeding pipe configured to feed the fluid inside the bag, the feeding pipe extending into the bag; and a seismic sensor attached to the support member. The seismic sensor is located inside the bag.

According to still another embodiment, there is a seismic sensor system for collecting seismic data in a well. The system includes a pipe configured to be lowered into the well, the pipe having an open end; a bag attached to the pipe at the open end and configured to contain a fluid; a feeding pipe configured to feed the fluid inside the pipe; and a seismic sensor located inside the pipe, near its open end. The seismic sensor is located inside the bag.

According to yet another embodiment, there is a seismic sensor system for collecting seismic data in a well. The system includes a flexible bag; a seismic sensor located inside the flexible bag and configured to detect seismic data; and a support member attached to the flexible bag. A hardening material is poured over the flexible bag when inside the well so that the hardening material is distributed below, on the side and above the flexible bag.

### BRIEF DESCRIPTION OF THE DRAWINGS

For a more complete understanding of the present invention, reference is now made to the following descriptions taken in conjunction with the accompanying drawings, in which:

FIG. 1 illustrates a vertical arrangement of hydrophones deployed in a well;

FIG. 2 is a schematic diagram of a retrievable vertical hydrophone cable according to an embodiment;

FIG. 3 illustrates a retrievable vertical hydrophone cable deployed in a well according to an embodiment;

FIG. 4 is a flowchart of a method for deploying a retrievable vertical hydrophone cable in a well according to an embodiment;

FIG. 5 is a schematic diagram of horizontally deployed hydrophones;

FIG. 6 is a schematic diagram of vertically deployed hydrophones according to an embodiment;

FIG. 7 is a schematic diagram of a hydrophone located in a bag in a well according to an embodiment;

FIG. 8 is a schematic diagram of another hydrophone located in a bag in a well according to an embodiment;

FIGS. 9A and 9B are schematic diagrams of still another hydrophone located in a bag in a well according to an embodiment;

FIGS. 9C and 9D are schematic diagrams of another hydrophone located in a bag in a well according to an embodiment;

FIG. 10 is a schematic diagram of a hydrophone located in a pipe in a well according to an embodiment;

FIG. 11 is a schematic diagram of a hydrophone fixedly attached to a well according to an embodiment; and

FIG. 12 is a schematic diagram of a seismic sensor placed in a bag and the bag placed in a net according to an embodiment.

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a land buried hydrophone. However, the embodiments to be discussed next are not limited to a land buried hydrophone, but may be applied to a combination of hydrophones and geophones.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment illustrated in FIG. 2, a retrievable vertical hydrophone cable 200 includes an envelope 202 that has, at one end 202A, a connector mechanism 204 and, at the other end 202B, a cap 206 so that a fluid 208 provided inside envelope 202 does not leak to the ambient. Connector mechanism 204 is configured to hydraulically connect the inside of envelope 202 to a pump (not shown) or a fluid source for providing fluid 208. A pressure of fluid 208 inside the envelope may be controlled, as will be discussed later.

Further, connector mechanism 204 and cap 206 are so configured that fluid 208 does not leak outside envelope 202 when the fluid 208 is pressurized. An electric cable 210 connects connector mechanism 204 to each of the hydrophones 212 distributed inside vertical or slanted hydrophone cable 200. In the following, it is noted that the term “vertical” means that an angle formed between hydrophone cable 200 and gravity is smaller than a few degrees, e.g., smaller than 10 degrees. A slanted cable makes an angle larger than 10 degrees.

Hydrophone 212 includes a casing 212A inside which is provided a hydrophone sensor 212B. A hydrophone sensor is configured to detect pressure changes. As the hydrophone is configured to detect a pressure change in the environment, hydrophone 212 is floating in fluid 208, which transmits the pressure changes from the envelope. Thus, envelope 202 is made of a flexible material, for example, polyurethane. In this way, any pressure change in the dirt around vertical hydrophone cable 200 is accurately transmitted to envelope 202, then to fluid 208, and finally to hydrophone 212.

To improve the coupling between envelope 202 and the ambient soil 300 of a well 302, as shown in FIG. 3, fluid 208 is pressurized by a pump 308. The fluid 208 inside envelope 202 hydraulically communicates with pump 308 through connector mechanism 204. Connector mechanism 204 also provides data communication and/or power supply through the electric cable 210, which is also connected to the hydrophones.

Fluid 208 may be a bio-degradable oil, mineral oil, water, etc. One purpose of fluid 208 is to ensure better contact between the envelope (and consequently the hydrophone) and the walls of the well. This is further explained next while also explaining how the retrievable vertical hydrophone cable is deployed and retrieved from a well.

The retrievable vertical hydrophone cable 200 is initially inserted into the well 302 having a given amount of fluid 208. This fluid is not under pressure except its own hydrostatic pressure. A distance h1 between connector mechanism 204 and the first hydrophone 212 is about 2 to 4 m. A distance between adjacent hydrophones is about 1.5 to 3 m. Other distances may be used as a function of the goals of the seismic survey. Any number of hydrophones may be attached to vertical hydrophone cable 200. However, a length of vertical hydrophone cable 200 is between 3 and 10 m.

To easily insert vertical hydrophone cable 200 into well 302, the external diameter d1 of retrievable vertical hydrophone cable 200, i.e., an external diameter of envelope 202, is slightly smaller than the internal diameter d2 of well 302. Once the retrievable vertical hydrophone cable 200 is in place, a gap 304 (exaggerated in FIG. 3; however, for a practical application, if the diameter d1 is about 4 cm, then the internal diameter d2 of the well 302 is desired to be about 5 cm) between envelope 202 and the walls of well 302 is reduced by pressurizing fluid 208 with pump 308. As a result of this action, the volume of envelope 202 increases and, thus, the external surface of envelope 202 presses against well 302, reducing or eliminating the gap 304. In this way, the coupling between hydrophone 212 and well 302 is improved. Connector mechanism 204 may be directly connected to pump 308 or together with similar connector mechanisms from other retrievable vertical hydrophone cables.

Fluid 208 is trapped inside the envelope and is not supposed to escape outside the envelope except in a controlled way through connector mechanism 204. In the event that the envelope's integrity is compromised, if fluid 208 is a bio-degradable oil or water, there is minimal impact to the environment. Other types of fluids may be used.

Seismic data from the hydrophones is collected through the electrical cable 210, which connects each hydrophone to connector mechanism 204. Thus, connector mechanism 204 is an electric and hydraulic connector.

After the seismic survey has been completed, to retrieve the retrievable vertical hydrophone cable 200, some of fluid 208 is released from envelope 202 or its pressure is decreased, so that the envelope is deflated (i.e., its volume is reduced) to not be in tight contact with the walls of well 302. In this way, retrievable vertical hydrophone cable 200 can easily be returned to the surface.

The above process may be summarized based on the flowchart shown in FIG. 4 as follows. FIG. 4 illustrates a method for deploying a retrievable vertical hydrophone cable for collecting seismic data. The method includes a step 400 of inserting an envelope that includes plural hydrophones into the well, wherein the plural hydrophones are surrounded by a fluid trapped inside the envelope; a step 402 of pressurizing the fluid while the envelope is inside the well to increase its volume until an exterior surface of the envelope contacts walls of the well; and a step 404 of recording seismic data with the hydrophones. Optionally, the method may include a step of removing some of the fluid from the envelope to reduce its volume and form a gap between the exterior surface of the envelope and the walls of the well, and a step of removing the retrievable vertical hydrophone cable from the well.

Note that the retrievable vertical hydrophone cable is intended to replace traditional geophones 500 that are deployed, in a horizontal manner, above or below ground 502 as illustrated in FIG. 5. In this way, instead of having a single geophone 500 at a given X and Y position, a string of hydrophones is deployed at the same X and Y position, each hydrophone 212 of the cable 200 having a different depth Z as illustrated in FIG. 6. In this way, it is expected, besides a better coupling, to eliminate horizontal filtering which currently reduces noise but damages the signal, and also to record the seismic data in a quieter environment. Additionally, it is expected to observe a lower level of ground roll and to use some properties of Rayleigh waves to separate them from signal.

In another embodiment illustrated in FIG. 7, a system 700 for detecting seismic waves includes a hydrophone 702 and a geophone 704. Geophone 704 may be a three-component (3C) geophone, i.e., a device that records ground displacements along three perpendicular directions. Both hydrophone 702 and geophone 704 may be located inside a pipe 710, toward its distal end 710A. In one application, end 710A has one or more opening. Pipe 710 may be a PVC pipe or any other pipe. Pipe 710 is placed inside a bladder jacket 712 that may be made of polyethylene or other flexible and resistant material (e.g., polyethylene with nitrile rubber). In one embodiment, the bladder jacket is flexible enough to follow a profile of the well. Bladder jacket 712 may be in direct contact with the walls of the well 720. Water or another fluid 722 may be provided inside pipe 710 and bladder jacket 712. In this way, a contact (coupling) between well 720 and fluid 722 is large, which results in a coupling between hydrophone 702 and fluid 722 being large. Holes 730 are formed in the walls of pipe 710, so that fluid 722 is also found inside pipe 710. Holes 730 are formed, in one application, around the position of the hydrophone 702. Pipe 710 and bladder jacket 712 may be sealed with a sealing member 732 so that the fluid cannot escape.

A pipe 740 may be configured to enter inside pipe 710, past the sealing member 732, to supply fluid 722. A pump 742 supplies fluid 722 and the pump is located at the surface 760. One or more electrical wires 750 connect the hydrophone and geophone to a recording unit 752, also located at the surface 760. In one application, a clamping mechanism 770 may be attached to pipe 710. Clamping mechanism 770 is deployed when pipe 710 is in place and achieves a better coupling of the geophone with the well. Thus, for this reason, clamping mechanism 770 is located next to geophone 704. The clamping mechanism may be retrievable, i.e., it may have a biasing mechanism 772 (e.g., spring) that may be remotely controlled to be retrieved inside or next to pipe 710. The bladder jacket may be left behind after the sensors and corresponding pipes are retrieved. In one application, pipe 710 may accommodate a vertical hydrophone and/or geophone cable.

Another embodiment is illustrated in FIG. 8, and this shows a hydrophone located inside a bag. More specifically, FIG. 8 shows a system 800 that includes a hydrophone 802 located at the end of a support 804 and inside a fluid 806 contained by the bag 808. Bag 808 is sealed so that the fluid cannot escape. When the hydrophone is lowered into well 810, bag 808 may be empty. After hydrophone 802 is in position, fluid 806 is pumped through a feeding pipe 814 inside bag 808. Feeding pipe 814 may extend toward the bottom of bag 808. An optional pipe 816 (air bleed pipe) may also be attached to bag 808 and provide an escape path for air trapped inside bag 808. For this reason, an end of the air bleed pipe is as close as possible to a top of bag 808. It is undesirable to have any air inside the bag because the air negatively affects the sensitivity of the hydrophone.

In one application, a diameter D of the bag is much larger than a diameter d of the hydrophone, e.g., D may be 4 inches (e.g., it may match the diameter of the well) and d may be 2 inches (e.g., it is half or less the diameter of the bag). A height H of bag 808 may be around 12 to 15 inches. A depth of the bag relative to the surface 820 may be between 2 to 20 m.

Next, a process of deploying system 800 is addressed. After well 810 is drilled (manually or with a small rig because its depth is not more than 30 m) to have diameter D, support 804 (having the hydrophone and bag attached to its end as illustrated in FIG. 8) is lowered into the well. At this time the bag is empty, so it has almost no volume. After the hydrophone (or any appropriate sensor or a combination of sensors) has reached its intended depth, fluid 806 is pumped, e.g., by a pump (not shown) at the surface through feeding pipe 814 inside bag 808. In one application, to reduce a danger of introducing too much fluid into the bag, a predetermined amount of fluid is inserted. In one application, a relief valve 860 may be attached to the bleed pipe 816 so that fluid inside the bag escapes when a certain pressure is reached to prevent bursting the bag. In still another application, the bleed pipe may be cut at a predetermined height above the bag, less than a depth of the bag. In this way, the fluid will fill to this point and then escape, thus avoiding a pressure too high in the bag. The bag takes the shape shown in FIG. 8 and achieves good coupling with the ground. Thus, the ground-fluid and the fluid-sensor interfaces provide a good coupling. When it is time to retrieve the sensor, there are various way to achieve it.

One way is to retrieve the sensor and not the bag. For this embodiment, the bag is left behind. This may be especially convenient when debris 840 partially covers bag 808. Thus, by pulling support 804 up, a connection 830 between bag 808 and support 804 may be broken so that the bag is left behind and the sensor is pulled up. In another embodiment, a string 832 may be connected with one end to connection 830 and with another end to the surface so that an operator (not shown) can manually disconnect the bag from the support.

Still in another embodiment, it is possible that debris 840 is removed prior to pulling bag 808 outside the well. In one application, it is possible to use a pneumatic drill that pumps compressed air to remove the debris about the bag. In another embodiment, it is possible to place a debris barrier 850 above the bag. When it is time to remove the bag, the debris barrier may be lifted from the surface to remove all the debris, and then the bag may be retrieved. To lift the debris barrier, it is possible to fixedly attach it to support 804 or to have a dedicated mechanism (e.g., chain) 852 for pulling up the barrier independent of the bag and sensor. FIG. 8 shows a chain, but those skilled in the art would understand that mechanism 852 may include more chains and/or other strength elements.

The length of the bag and its shape may vary. Some of the above embodiments have shown the bag extending from the surface to the bottom of the well, others have shown the bag being localized, i.e., extending only around a sensor at the bottom of the well. For this last case, it is possible to add a weight 900 on top of bag 808 for achieving a better coupling with the well, as illustrated in FIG. 9A. For this application, no pipe supplying the fluid 806 may be necessary. In other words, the fluid is already in the bag when the bag is lowered to the bottom of the well. However, when the sensor is in place, the bag may not achieve a good contact with the walls of the well. For this reason, weight 900 is added to force the bag to be in contact as much as possible with the walls of the well. In a different application, as illustrated in FIG. 9B, feeding pipe 814 is present but no weight is necessary. In this application, the shape of the bag is chosen depending on the need, for example, to have a cylindrical or an ellipsoidal cross section.

In still another embodiment, illustrated in FIGS. 9C and 9D, a bag assembly 908 includes a bag 808 prefilled with fluid 806 such that no air is entrapped inside the bag, but only the hydrophone 802. Two weights 900A and 900B are attached to bag 808, the first weight 900A to a top of bag 808 and the second weight 900B to a bottom of bag 808. Hydrophone 802 is attached to support 804 (e.g., a wire or cable) while the first weight 900A is attached to a support wire 910. In one application, support 804 provides not only support to the hydrophone but also power supply and/or data exchange for the recorded seismic data. When assembly 902 is lowered into well 810, the second (bottom) weight 900B exerts a force F1 as illustrated in FIG. 9C, which makes the walls of bag 808 to act on fluid 806 with forces F3. Thus, bag 808 takes an elongated shape that promotes the sliding of the assembly into the well. When the second weight 900B has reached the bottom of well 810 as illustrated in FIG. 9D, the first (top) weight 900A exerts a force F2 that makes bag 808 expand its walls against well 810, thus acting with force F3 against the well, increasing the bag-well coupling. For this position, the support 910 needs to be slack. To remove the assembly, support 910 is pulled up, which determine the bag to elongate and easier exit the well.

According to another exemplary embodiment illustrated in FIG. 10, a system 1000 includes a sensor (e.g., hydrophone) 1002 attached to a support 1004. Bag 1008 is now connected to an open end 1010A of pipe 1010 that accommodates sensor 1002. Fluid 1006 is provided inside bag 1008 through a feeding pipe 1014, from the surface 1020. A casing of sensor 1002 is connected with a connector 1016 to the inside of pipe 1010. After the sensor is in place inside the well 1012, bag 1008, which may be stored inside pipe 1010, e.g., at location 1018, is deployed by being filled with fluid 1006, thus occupying the bottom of the well. For better coupling and noise reduction, filing material (e.g., sand) may be distributed around pipes 1010 and 1014 and over bag 1008. More fluid 1006 may be pumped, after which feeding pipe 1014 is closed.

A barrier 1040 may be located inside pipe 1010, above sensor 1002 to prevent vibrations and to provide acoustic insulation properties. Barrier 1040 may be fixed relative to pipe 1010 and may be made of a solid (rigid) material. Barrier 1040 is made to withstand water pressure if water 1042 is added above it. Also, the barrier may be configured to insulate water 1042 from fluid 1006. When it is time to retrieve the sensor, the bag may be emptied (partially or totally) of the fluid and then left behind, similar to the embodiment discussed with regard to FIG. 8. Alternatively, the bag may be retrieved together with pipe 1010 by first removing the fluid from the bag, then creating a soft vacuum inside pipe 1010 to retrieve the bag inside volume 1018 of the pipe, and then removing the pipe from the well.

A more permanent assembly is now discussed with regard to FIG. 11. For this embodiment, the assembly is fixed inside the well, for example, by being encased in cement, grout or other appropriate hardening material. In this way, a pressure of the fluid inside the assembly cannot be increased after the material hardens, thus, preventing the assembly to burst. Also, it was observed that a coupling to the formation is improved.

In more detail, FIG. 11 shows assembly 1100 having a hydrophone 1102 located inside a flexible bag 1108. Flexible bag 1109 is filled with a fluid 1106, slightly over-pressured and all air bled out and sealed. Assembly 1100 is then lowered in well 1110 and then, a controlled amount of low viscosity cement or grout or other appropriate material 1140 is poured into the well, enough to fill below, around and above assembly 1100 as illustrated in FIG. 11. This operation may be continued until material 1140 reaches a predetermined height h relative to a top of bag 1108. The pressure of material 1140 slights compresses flexible bag 1108 and then material 1140 sets up solidly enclosing the bag. Thus, a good coupling (cement coupling) is achieved between bag 1108 and well 1110 and the hydrophone is present in a volume of fluid 1106 that is rigidly constraint.

This embodiment is more successful during installation than traditional configurations because there is no danger of having a hydrostatic head in the hoses connecting the bag that can reach very high pressures, rupturing the flexible bag. This possibility does not happen in this embodiment as the pressures are more balanced because of the external pressure of the cement and any additional head of water. In a deep borehole, if there is significant head of water or drilling fluid, a large pressure can be exerted externally on the flexible bah. To prevent this pressure on acting on the bag, it is possible to blow compressed air to clear the drilling fluid, before inserting the assembly and the cement. In this way, the maximum external pressure is controlled by the head of cement.

With respect to one or more of the embodiments discussed above, if it is desired to reuse the bag when the sensor is pulled out of the well, care needs to be exercise for preventing the bag to being punctured by rock formations in the well. One way to avoid such undesirable outcome, is to provide a net 1230 over bag 1208 as illustrated in FIG. 12. System 1200 illustrated in this figure has sensor 1202 inside bag 1208 and bag 1208 inside the net 1230. Net 1230 may be connected to one or more ropes (or other support elements, e.g., cable, wire, etc.) 1240 which are pulled from outside the well 1210 when the bag needs to be recovered. In this way, the bag is protected by the net from puncturing and also a weight of the bag is distributed on the net, making the retrieval of the bag easier. The eye of the net may vary from application to application, depending on the depth of the well and the weight of the fluid inside the bag. In one application, net 1230 may be a Chinese finger type of net, i.e., a net that tighten when rope 1240 is pull, thus, squeezing the bag during retrieval. When rope 1240 is relaxed, the net also relaxes, making the bag to follow the well's contour, and thus, to achieve a better coupling.

The disclosed exemplary embodiments provide a method and a retrievable hydrophone. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A seismic sensor system for collecting seismic data in a well, the system comprising:
a pipe to be deployed inside the well, the pipe having a distal end;
a first sensor located inside the pipe, next to the distal end; and
a bladder jacket in which the pipe is placed, the bladder jacket being configured to hold a fluid,
wherein the pipe has holes next to the first sensor so that the fluid surrounds and contacts the first sensor.

2. The system of claim 1, further comprising:
a second sensor located inside the pipe, further away from the distal end then the first sensor.

3. The system of claim 2, wherein the first sensor is a hydrophone and the second sensor is a geophone.

4. The system of claim 2, further comprising:
a clamping mechanism attached to the pipe and configured, when deployed, to better couple the second sensor to the well.

5. The system of claim 1, wherein the bladder jacket is made of a flexible material that can follow a profile of the well.

6. The system of claim 1, wherein the bladder jacket extends from a bottom of the well to the surface.

7. A seismic sensor system for collecting seismic data in a well, the system comprising:
a support member configured to be lowered into the well;
a bag attached to the support member and configured to contain a fluid;
a feeding pipe configured to feed the fluid inside the bag, the feeding pipe extending into the bag; and
a seismic sensor attached to the support member,
wherein the seismic sensor is located inside the bag.

8. The system of claim 7, further comprising:
an air bleed pipe configured to enter the bag and evacuate air bubbles from inside the bag.

9. The system of claim 8, wherein the bag is hermetically closed and its content enters or exits the bag only through the feeding pipe and the air bleed pipe.

10. The system of claim 7, wherein the seismic sensor is a hydrophone and the bag is located inside a net.

11. The system of claim 7, wherein a diameter D of the bag matches a diameter of the well while a diameter d of the seismic sensor is half or less than the diameter D of the bag.

12. The system of claim 11, wherein, after the bag is deployed and filled with water, fill-in material is fed into the well to cover the bag.

13. The system of claim 7, further comprising:
a connection connecting the bag to the support member and configured to detach when retrieving the support member so that the bag remains in the well.

14. The system of claim 7, further comprising:
a weight located on the seismic sensor and configured to press on the bag so that the bag more closely follows a profile of the well.

15. The system of claim 7, wherein the bag has an ellipsoidal cross-section.

16. A seismic sensor system for collecting seismic data in a well, the system comprising:
a pipe configured to be lowered into the well, the pipe having an open end;
a bag attached to the pipe at the open end and configured to contain a fluid;
a feeding pipe configured to feed the fluid inside the pipe; and
a seismic sensor located inside the pipe, near its open end,
wherein the seismic sensor is located inside the bag.

17. The system of claim 16, wherein the bag is stored inside the pipe prior to being filled with the fluid.

18. The system of claim 16, further comprising:
a support element to which the seismic sensor is attached.

19. The system of claim 16, further comprising:
a barrier element located inside the pipe and insulating the seismic sensor from vibrations and/or noise.

20. A seismic sensor system for collecting seismic data in a well, the system comprising:
a flexible bag;
a seismic sensor located inside the flexible bag and configured to detect seismic data; and
a support member attached to the flexible bag,
wherein a hardening material is poured over the flexible bag when inside the well so that the hardening material is distributed below, on the side and above the flexible bag.
